(19) United States
(12) Patent Application Publication
(10) Pub. No.: US 2006/0115672 A1
(43) Pub. Date: Jun. 1, 2006

(54) Method of manufacturing a laminated structure

(75) Inventors: Roger De Gryse, Oosterzele (BE); Jurgen Denul, Deinze (BE); Anneke Segers, Gent (BE); Hugo Lievens, Gent (BE)

Correspondence Address: FOLEY AND LARDNER LLP;SUITE 500, 3000 K STREET NW, WASHINGTON, DC, 20007, US

(73) Assignee: N.V. BEKAERT S.A.

(21) Appl. No.: 10/546,565

(22) PCT Filed: Feb. 19, 2004
(86) PCT No.: PCT/EP04/50155

§ 371 Date: Nov. 15, 2005

(30) Foreign Application Priority Data
Feb. 20, 2003 (EP) 03100405.4

(51) Int. Cl. B32B 37/00; B29C 65/00

(52) U.S. Cl. 428/689; 361/311; 156/272.2; 156/280; 428/930

(57) ABSTRACT

The invention relates to a method of manufacturing a laminated structure. The method comprises the steps of: providing at least a first and a second flexible structure; applying a coating on at least a part of said first and said second flexible structure to obtain a first coated flexible structure and a second coated flexible structure; bringing the coated surface of said first coated flexible structure and the coated surface of said second coated flexible structure together and pressing said first coated flexible structure and said second coated flexible structure together to create a cold welding between said first coated flexible structure and said second coated flexible structure. The invention further relates to a laminated structure comprising a first flexible structure and a second flexible structure being bonded by means of a cold welding.

### FIELD OF THE INVENTION

The invention relates to a method of manufacturing a laminated structure.

The invention further relates to a laminated structure obtained by this method and to the use of such a laminated structure as capacitor or superconductor.

### BACKGROUND OF THE INVENTION

In order to obtain a laminated structure of two coated flexible substrates, one often uses an adhesive such as a glue or an organic resin.

However, this method has the drawback that the coating can be damaged by the adhesive.

### SUMMARY OF THE INVENTION

It is an object of the present invention to provide a method of manufacturing a laminated structure thereby avoiding the problems of the prior art.

It is a further object to provide a laminated structure and the use of such a laminated structure as capacitor or superconductor.

According to a first aspect of the present invention, a method of manufacturing a laminated structure is provided. The method comprises the steps of
providing at least a first and a second flexible structure;
applying a coating on at least a part of the first and the second flexible structure to obtain a first coated flexible structure and a second coated flexible structure;
bringing the coated surface of the first coated flexible structure and the coated surface of the second coated flexible structure together and pressing the first coated flexible structure and the second coated flexible structure together to create a cold welding between the first coated flexible structure and the second coated flexible structure.

The coating on the first and the second flexible structure can be applied by any technique known in the art as for example wet chemical deposition techniques or vacuum deposition techniques.

Preferably, the coating on the first and the second flexible structure is applied by means of vacuum deposition techniques such as sputtering, for example magnetron sputtering, ion beam sputtering and ion assisted sputtering, evaporation, laser ablation or chemical vapor deposition such as plasma enhanced chemical vapor deposition.

The metal coating may comprise any metal or metal alloy. Preferred metal layers comprise for example Al, Ti, V, Cr, Co, Ni, Cu, Zn, Rh, Pd, Ag, In, Sn, Ir, Pt, Au, Pb or alloys thereof.

Preferably, the coating applied on the first flexible structure is Identical to the coating applied on the second flexible structure.

The coating on the first flexible structure and the coating on the second flexible structure can be applied by one deposition source or by two different deposition sources. The application by one deposition source is preferred.

A cold welding may occur when two dean metal surfaces are brought into intimate contact.

To obtain a cold welding, the metal surfaces have to be free of contamination, such as oxides, nitrides, absorbed gases or organic contaminations. In addition, the metal surfaces have to be brought together under sufficient high mechanical force to bring the atoms at the interface into intimate contact

The elimination of contamination can be obtained by cleaning the metal surface.

In a preferred embodiment, the application of the coating and the cold welding of the first and second coated flexible structure is performed in a vacuum without breaking the vacuum between the coating step and the cold welding step.

By maintaining the vacuum through the process steps, one prevents the formation of surface oxides and other contaminations.

Furthermore, by performing the different process steps in one process chamber, the need to relocate or otherwise move the flexible structures between different process chambers is eliminated.

The first and the second flexible structure may comprise any flexible substrate known In the art, as for example a flexible metal substrate or a flexible polymer substrate.

Preferred flexible metal substrates comprise for example metal tapes or foils or metallized tapes or foils.

The metal comprises preferably steel, nickel or nickel alloys, or titanium or titanium alloys.

The metal substrate preferably has a thickness between 1 and 100 μm, as for example 10 μm.

Metallized tapes or foils comprise preferably a polymer tape or foil coated on both sides with a metal layer.

Preferred flexible polymer substrates comprise for example polymer tapes or foils such as polyester (PET), polypropylene such as oriented polypropylene (OPP) and bioriented polypropylene BOPP), polyetherimide or polyimide (for example known as Kapton® or Uppilex®) tapes or foils.

In a preferred embodiment, the first and/or the second flexible structure comprises a coated flexible substrate as for example a metal tape or foil or a metallized tape or foil coated with a ceramic layer or a polymer foil or tape coated with a metal layer.

The fist and the second flexible structure may comprise the same material or may comprise a different material.

The ceramic layer is preferably selected from the group consisting of oxides, titanates, niobates, zirconates and high temperature superconductors such as (Re)—Ba—Cu-oxides. (Re) may comprise one or more rare earth elements as for example Y or Nd.

Some common titanates used for capacitors comprise CaTiO₃, SrTiO₃, BaTiO₃ and PbTiO₃, (Ba,Sr)TiO₃, PbZr₍₁₋ₓ₎TiₓO₃, Sr₍₁₋ₓ₎BiₓTiO₃. NbₓTiO₃, BiBi₂NbTiO₉, BaBi₄Ti₄O₁₅, Bi₄Ti₃O₁₂, SrBi₄Ti₄O₁₅, BaBi₄Ti₄O₁₅, PbBi₄Ti₄O₁₅ or PbBi₄Ti₄O₁₅.

Some niobates comprise CaBi₂Nb₂O₉, SrBi₂Nb₂O₉, BaBi₂Nb₂O₉, PbBi₂Nb₂O₉, (Pb,Sr)Bi₂Nb₂O₉, (Pb,Ba)Bi₂NbO₉, (Ba,Ca)Bi₂Nb₂O₉, (Ba,Sr)Bi₂Nb₂O₉, BaBi₂Nb₂O₉, PbBi₂Nb₂O₉, SrBi₂Nb₂O₉, Ba_{0.75}Bi_{2.25}Ti_{0.25} Nb_{1.75}O₉, Ba_{0.5}Bi_{2.5}Ti_{0.5}Nb_{1.5}O₉, Ba_{0.25}Bi_{2.75}Ti_{0.75}Nb_{1.25}O₉, Bi₃TiNbO₉, Sr_{0.8}B_{2.2}Ti_{0.2}Nb_{1.8}O₉, Sr_{0.6}Bi_{2.4}Ti_{0.4}Nb_{1.6}O₉. Bi₃TiNbO₉, Pb_{0.75}, Bi_{2.25}Ti_{0.25}Nb_{1.75}O₉, Pb_{0.6}Bi_{2.5}Ti_{0.5}Nb_{1.5}O₉, Pb_{0.25}Bi_{2.75}Ti_{0.75}Nb_{1.25}O₉ or Bi₃TiNbO₉.

Common oxides comprise Ta₂O₅, SiO₂, Al₂O₃, TiO₂ and (Re)—Ba—Cu-oxides.

Also ceramic layers comprising lead zirconate titanate (PZT) and lead zirconate lanthanum modified titanate (PZLT) can be used.

The ceramic layer can be deposited by a number of different techniques such as sputtering for example magnetron sputtering, ion beam sputtering and ion assisted sputtering, evaporation, laser ablation, chemical vapor deposition or plasma enhanced chemical vapor deposition.

Possibly, the first and/or the second flexible structure comprise an intermediate layer layer between the flexible substrate and the ceramic layer. This intermediate layer comprises for example a buffer layer. The buffer layer may comprise a metal layer such as a noble metal layer or an oxide layer such as yttrium stabilized zirconium layer, a CeO₂ layer or a Y₂O₅ layer.

The method as described above is in particular suitable to manufacture capacitors or to manufacture superconductors.

A great advantage of the method according to the present invention is that laminated structures can be manufactured without using organic adhesives such as glues.

It is known in the art that ceramic layers and more particularly ceramic layers used for superconductors are brittle layers and may suffer seriously from cracking by bending the material.

The method according to the present invention allows to reduce the stress on the ceramic layer by putting the ceramic layer in a laminated structure. The ceramic layer can be brought close to the so-called neutral axis by choosing the thickness of the different layers and/or the Young's modulus of the different layer.

The neutral axis is defined as the axis of the layered structure which under bending undergoes neither compression nor elongation.

Furthermore, the method according to the present invention allows to obtain a good electrical and mechanical contact between the first and the second flexible structure and the coating layer.

According to a second aspect of the present invention, a laminated structure is provided. The laminated structure comprises a first flexible structure and a second flexible structure. The first flexible structure and the second flexible structure are bonded to each other by means of a metal layer. The metal layer is applied by applying a metal coating on at least a part of the first flexible structure and by applying a metal coating on at least a part of the second flexible structure, by bringing the coated surfaces of the first flexible structure and the second flexible structure together and by pressing the first flexible structure and the second flexible structure together to create a cold welding between the first flexible structure and the second flexible structure.

The metal coating forming the cold welding is free of contaminations.

The laminated structure according to the present invention does not make use of an organic adhesive such as a glue.

This is a great advantage as an organic adhesive may damage the substrate or the coating applied on the substrate.

According to a third aspect of the present Invention, the use of a laminated structure as capacitor Is provided.

A preferred capacitor is a wound capacitor comprising a laminated structure as described above.

Wound capacitors are known in the art. Generally, these capacitors comprise a pair of metallized polymer films wound together into a roll. The metallized films are obtained by depositing a thin layer of a conductive material onto a polymer film.

However, this type of capacitors shows a number of drawbacks. The polymer films are characterized by a limited relative dielectric constant εᵣ.

Also the thickness of the polymer film (dielectricum) can not be lower than a certain minimum value, generally 0.7 μm.

As the capacitance of a capacitor is determined as

$$c = {ɛ}_{0} {ɛ}_{r} \frac{S}{{d}_{d}}$$

with
S: the area of the capacitor;
d_{d}: the thickness of the dielectricum (the separation distance between two metal layers);
ε₀: the dielectric constant of vacuum;
εᵣ: the relative dielectric constant of the dielectricum;
   only moderate capaciance values can be reached.

Preferred wound capacitors according to the present invention comprise a laminated structure having a first and a second flexible substrate.

The first and the second flexible substrate comprise a metal substrate and a ceramic layer (dielectric layer). The ceramic layer is preferably deposited by means of a vacuum deposition technique.

The first and the second flexible substrate are bonded to each other by means of a metal layer.

The metal layer is preferably applied by applying a metal coating on at least a part of the first flexible structure and by applying a metal coating on at least a part of the second flexible structure, by bringing the coated surfaces of the first flexible structure and the second flexible structure together and by pressing the first flexible structure and the second flexible structure together to create a cold welding between the first flexible structure and the second flexible structure.

The coating on the first and the second flexible structure can be applied by any technique known in the art as for example wet chemical deposition techniques or vacuum deposition techniques.

Preferably, the coating on the first and the second flexible structure is applied by means of vacuum deposition techniques such as sputtering, for example magnetron sputtering, ion beam sputtering and ion assisted sputtering, evaporation, laser ablation or chemical vapor deposition such as plasma enhanced chemical vapor deposition.

The metal coating may comprise any metal or metal alloy. Preferred metal layers comprise for example Al, Ti, V, Cr, Co, Ni, Cu, Zn, Rh, Pd, Ag, In, Sn, Ir, Pt, Au, Pb or alloys thereof.

Preferably, the coating applied on the first flexible structure is identical to the coating applied on the second flexible structure.

The coating an the first flexible structure and the coating on the second flexible structure can be applied by one deposition source or by two different deposition sources. The application by one deposition source is preferred.

A wound capacitor according to the present invention shows many advantages. Some of these advantages are related to the deposition of the ceramic layers.

First of all, dielectric material having a high relative dielectric constant εᵣ can be obtained by means of vacuum deposition. As described above the relative dielectric constant εᵣ of the dielectric material is preferably higher than 20.

However, dielectric materials with a relative dielectric constant εᵣ that is much higher can be obtained.

Typical ranges of dielectric material are from 20 to 100, from 100 to 1000, from 1000 to 10000, from 10000 to 20000 and even higher than 20000.

A second advantage is that thin layers of dielectric layers can be deposited.

The thickness of the dielectric material can be much lower than the thickness of the dielectric material (i.e. the thickness of polymer films) in the known metallized film capacitors.

The minimum thickness that can be reached in the known metallized film capacitors is generally accepted to be 0.7 μm.

By vacuum deposition layers of 0.001 μm can be deposited. Generally, the thickness of a vacuum deposited dielectric layer is between 0.001 and 10 μm, as for example 1 μm, 0.1 μm or 0.01 μm.

Both the increase in the relative dielectric constant εᵣ and the reduction of the thickness of the dielectric material have a positive influence on the capacitance a capacitor.

A third advantage of a dielectric material deposited by a vacuum deposition technique is the high quality of the dielectric material that can be obtained and that the ease to control the thickness of the dielectric material.

Furthermore by depositing a dielectric material on a metal substrate higher temperature can be reached compared with metallized polymer films.

In a wound capacitor according to the present invention, the first and the second structure are bonded by means of a metal layer. This means that the use of organic adhesives such as a glue is avoided.

According to a fourth aspect of the present invention, the use of a laminated structure as superconductor is provided.

### BRIEF DESCRIPTION OF THE DRAWINGS

The invention will now be described into more detail with reference to the accompanying drawing wherein

FIG. 1 and FIG. 2 show schematic representations of the method according to the present invention to manufacture a lamiated structure;

FIG. 3 to 7 show different embodiments of capacitors;

FIG. 8 shows a laminated structure according to the present invention used as high temperature superconductor.

### DESCRIPTION OF THE PREFERRED EMBODIMENTS OF THE INVENTION

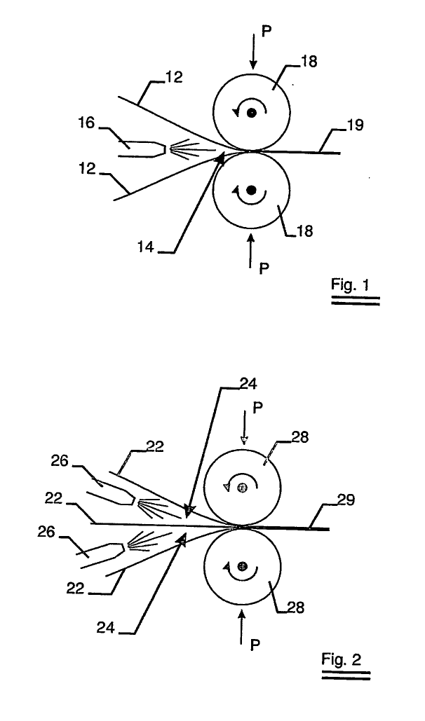

FIG. 1 shows a schematic representation of the method according to the present invention. Two flexible structures 12 comprising a metal foil coated with a ceramic layer are provided in a vacuum chamber. The two flexible structures 12 are coated from a deposition source 16 with a metal coating layer 14. Subsequently, the two coated flexible structures are united by pressing the laminated structure together between two rolls 18.

Between the two coated surface a cold welding is created.

The coating of the flexible structures 12 and the uniting of the two flexible structures by means of the coating layer 14 is preferably done in the vacuum chamber without breaking the vaccum.

Possibly, the method may be followed by other processing steps such as heating, coating, slitting, another lamination process . . .

FIG. 2 shows a schematic representation of a method according to the invention in which three flexible structures 22 are united by applying a metal coating 24 from deposition sources 26 between two consecutive flexible structures 22 and by pressing the laminated structure together between two rolls 28.

For a person skilled In the art it is dear that the number of flexible structures of the laminated structure can be increased. Generally, the number of flexible structures of a laminated structure ranges between 2 and 10.

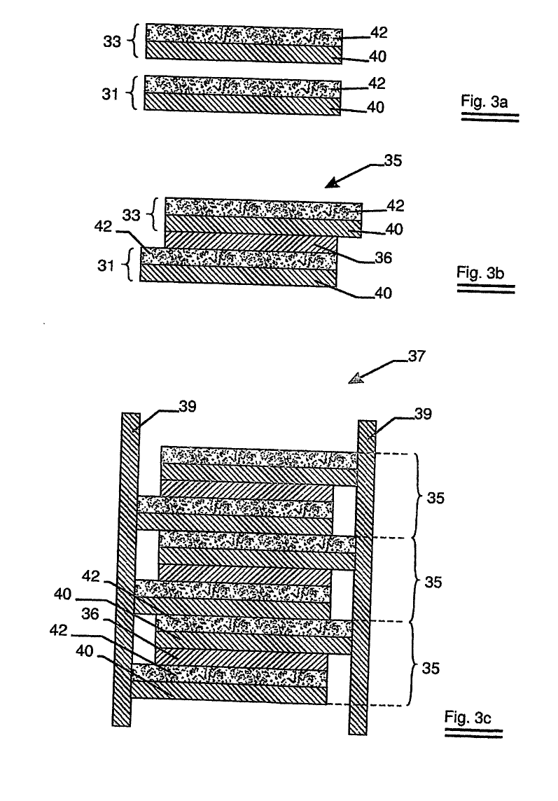

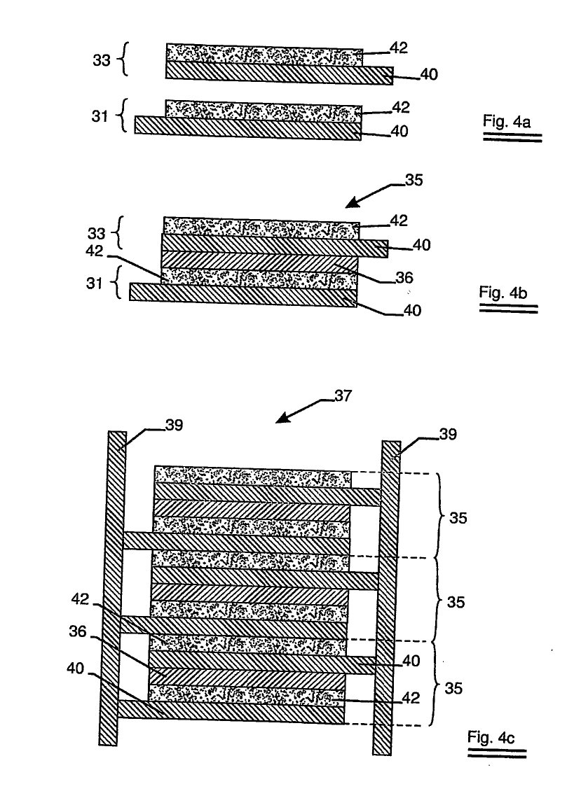

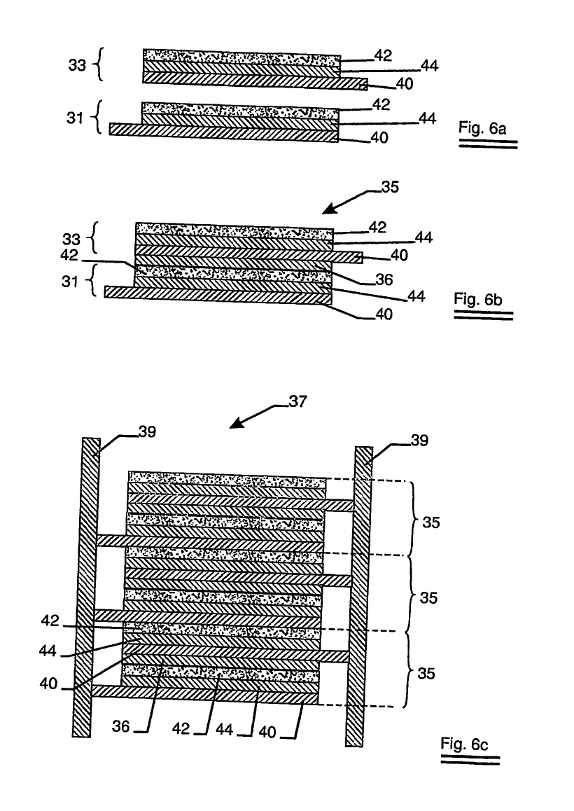

FIGS. 3 to 7 show different embodiments of capacitors.

The flexible structures 31, 33 that are laminated are shown in FIGS. 3a to 7a.

FIGS. 3b to 7b show the laminated structure 35 comprising the flexible structures 31, 33 bonded to each other by means of metal coating layer 36.

FIGS. 3c to 7c show a stack 37 of laminated structures 35 comprising electodes 39.

The flexible structures 31, 33 comprise a flexible substrate 40 and a ceramic layer 42.

Possibly, one or both of the flexible structure 31 or 33 comprise a buffer layer 44 between the substrate 40 and the ceramic layer 42.

The buffer layer 44 comprises for example a metal layer such as a noble metal layer for example Pd, Pt. Au or Ag.

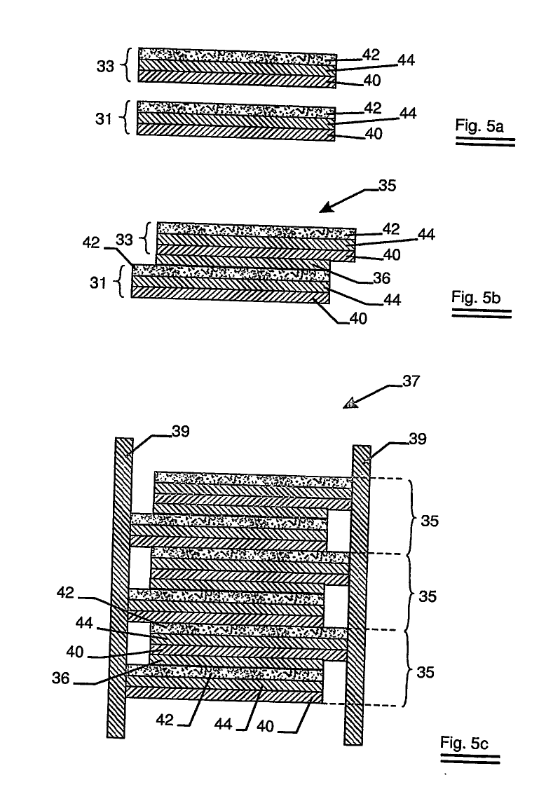

An example of an embodiment comprising a buffer layer 44 In the first and the second flexible structure is given in FIG. 5.

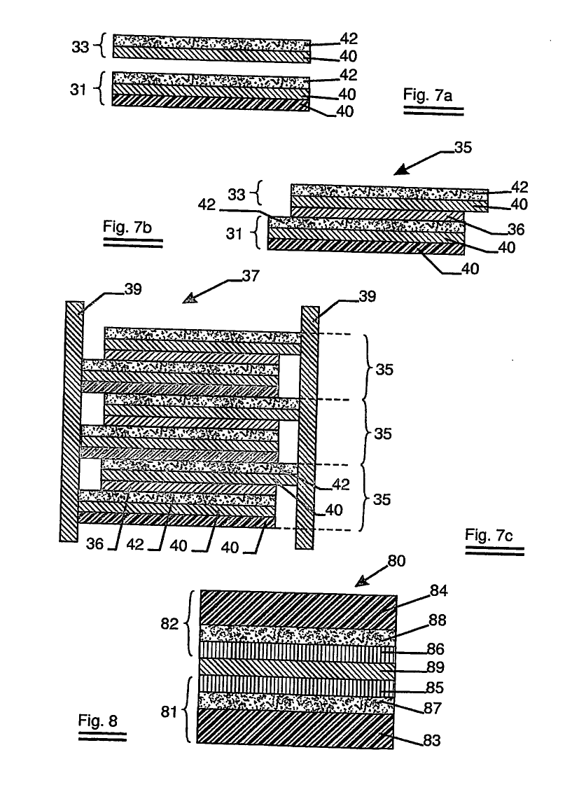

In the embodiments shown in FIG. 3 to 6, the flexible substrate comprises a metal tape or a metallized tape. In the embodiment shown In FIG. 7, the flexible substrate of the first flexible structure comprises a polymer tape.

To show the attractiveness of a capacitor according to the present invention, the capacitance per volume of a capacitor according to the present invention is compared with the capacitance per volume of a metallized film capacitor known in the art.

The capacitance per volume is defined as:

$$\frac{C}{V} = \frac{{ɛ}_{0} {ɛ}_{r}}{{d}_{d} {d}_{cap}}$$

with
ε₀: the dielectric constant of vacuum;
εᵣ the relative dielectric constant εᵣ constant of the dielectric material;
d_{d}: the thickness of the dielectric material (the separation distance between two metal layers);
d_{cap}: d_{d}+dₑ (with dₑ the thickness of the metal layer (the electrode)).

A metallized film capacitor comprises a metallized polymer film wound into a roll to form a capacitor. The metallized polymer film is formed by depositing a thin layer of a conductive material onto a polymer film.

The metallized film capacitor that is considered as an example comprises a polymer film (dielectricum) having a relative dielectric constant εᵣ₁ of 3.

As thickness of the polymer mm d_{d1}, the thinnest thickness known in the art is considered: 0.7 μm.

In case the metal layer on the polymer film is deposited on the polymer film by means of sputtering, the thickness of a metal layer can be considered to be very low. Therefore, in the above calculation d is considered to be equal to d_{d1}.

The capacitance per volume of the metalized film capacitor can be calculated as follows:

$$\frac{{C}_{1}}{{V}_{1}} = \frac{{ɛ}_{0} {ɛ}_{r 1}}{{d}_{d 1} {d}_{d 1}} .$$

As capacitor according to the present invention, a capacitor comprising a first and a second structure each comprising a metal substrate and a dielectric material deposited on this metal substrate is considered. The dielectric material has a relative dielectric constant ε_{r 2} of 500, a thickness of the dielectric material d_{d2} of 0.01 μm. The metal substrate (electrode) has a thickness of 10 μm.

The capacitance per volume is:

$$\frac{{C}_{2}}{{V}_{2}} = \frac{{ɛ}_{0} {ɛ}_{2 r}}{{d}_{d 2} {d}_{cap}} .$$

It can be concluded from the above mentioned examples that the capacitance per volume of the second capacitor is about 800 times higher than the capacitance per volume of the first capacitor.

It is dear that the above mentioned calculation may only be considered as an example. As the relative dielectric constant εᵣ of the dielectric material of a capacitor according to the present invnetion can be much higher than the one taken in the example and as the thickness of the dielectric material can be lower than the thickness considered in the example, capacitors with a much higher capacitance per volume can be obtained according to the present invention.

FIG. 8 shows a laminated structure according to the present invention used as high temperature superconductor.

High temperature superconductors (HTS) such as (Re)—Ba—Cu-oxides are brittle ceramic materials. Cracking of the brittle superconductor layer can cause dramatic reduction of the current conduction capacity (critical current J_{c}). In order to avoid this reduction of J_{c}, the bending radius of a non-laminated coated conductor has to be larger than a critical value that depends on the thickness of the HTS coating in a laminated structure, it should be possible to minimise the effect and thereby obtaining a conductor that can be bent to a smaller bending radius. By putting the HTS coating in a laminated structure, it should be possible to minimise the effect and thereby obtaining a conductor that can be bent to a smaller bending radius.

FIG. 8 shows an example of a laminated structure 80 in which the bending stress on the HTS Is minimal.

The laminated structure 80 comprises two flexible structures 81 and 82. Each flexible structure comprises a flexible substrate such as a metal foil or a polymer foil 83, 84 and a HTS coating 85, 86. Between the metal foil 83, 84 and the HTS coating 85, 86 a buffer layer 87, 88 is deposited. The two flexible structures 81 and 82 are united by means of coating layer 89.

By the presence of the flexible substrates 83, 84, the HTS coatings 85, 86 are brought closer to the so-called neutral axis.

The neutral axis is determined by the thicknesses of the respective layers and by their Young's moduli ε.

1. A method of manufacturing a laminated structure, said method comprising the steps of
providing at least a first and a second flexible structure;
applying a metal coating on at least a part of said first and said second flexible structure to obtain a first coated flexible structure and a second coated flexible structure;
bringing the coated surface of said first coated flexible structure and the coated surface of said second coated flexible structure together and pressing said first coated flexible structure and said second coated flexible structure together to create a cold welding between said first coated flexible structure and said second coated flexible structure.

2. A method according to claim 1, whereby said coating on said first and said second flexible structure is applied by a vacuum deposition technique.

3. A method according to claim 2, whereby the different process steps are performed in vacuum without breaking said vacuum between the process steps.

4. A method according to claim 1, whereby said first and said second flexible structure comprise a flexible metal substrate, a flexible polymer substrate or a flexible metallized polymer substrate.

5. A method according to claim 1, whereby said first flexible structure and said second flexible structure comprise a coated flexible substrate.

6. A method according to claim 5, whereby said coated flexible substrate comprises a metal foil or tape coated with a ceramic layer.

7. A method according to claim 6, whereby said ceramic layer is selected from the group consisting of oxides, titanates, niobates and zirconates.

8. A method according to claim 6, whereby said ceramic layer comprises a high temperature superconductor.

9. A method according to claim 5, whereby said coated flexible substrate comprises a polymer foil or tape coated with a metal layer.

10. A method according to claim 5, whereby said first and/or said second flexible structure comprise an intermediate layer between said flexible substrate and the coating applied on said flexible substrate.

11. A method according to claim 10, whereby said intermediate layer comprises a buffer layer comprising a yttrium stabilized zirconium layer, a CeO₂ layer or a Y₂O₃ layer.

12. A laminated structure comprising a first flexible structure and a second flexible structure, said first flexible structure and said second flexible structure being bonded to each other by means of a metal layer, said metal layer being applied by applying a metal coating on at least a part of said first flexible structure and by applying a metal coating on at least a part of said second flexible structure, by bringing the coated surfaces of said first flexible structure and said second flexible structure together and by and by pressing said first flexible structure and said second flexible structure together to create a cold welding between said first flexible structure and said second flexible structure.

13. A laminated structure according to claim 12, whereby said laminated structure is glue free.

14. A laminated structure according to claim 12, whereby said flexible substrate comprises a flexible metal substrate, a flexible polymer substrate or a flexible metallized polymer substrate.

15. A laminated structure according claim 12, whereby said first flexible structure and said second flexible structure comprise a coated flexible substrate.

16. A laminated structure according to claim 15, whereby said coated flexible substrate comprises a metal foil or tape coated with a ceramic layer.

17. A laminated structure according to claim 16, whereby said ceramic layer is selected from the group consisting of oxides, titanates, niobates and zirconates.

18. A laminated structure according to claim 16, whereby said ceramic layer comprises a high temperature superconductor.

19. A laminated structure according to claim 15, whereby said coated flexible substrate comprises a polymer foil or tape coated with a metal layer.

20. A laminated structure according to claim 15, whereby said first and/or said second flexible structure comprise an intermediate layer between said flexible substrate and the coating applied on said flexible substrate.

21. A laminated structure according to claim 20, whereby said intermediate layer comprises a buffer layer comprising a yttrium stabilized zirconium layer, a CeO₂ layer or a Y₂O₃ layer.

22. A capacitor comprising a laminated structure as defined in claim 12.

23. A capacitor according to claim 22, whereby said capacitor is a wound capacitor comprising a laminated structure comprising a first flexible structure and a second flexible structure, said first flexible structure and said second flexible structure being bonded to each other by means of a metal layer, said metal layer being applied by applying a metal coating on at least a part of said first flexible structure and by applying a metal coating on at least a part of said second flexible structure, by bringing the coated surfaces of said first flexible structure and said second flexible structure together and by and by pressing said first flexible structure and said second flexible structure together to create a cold welding between said first flexible structure and said second flexible structure.

24. A capacitor according to claim 23, whereby said laminated structure comprises a first flexible structure and a second flexible structure, said first flexible structure and said second flexible structure being bonded to each other by means of a metal layer, said metal layer being applied by applying a metal coating on said first flexible structure and by applying a metal coating on said second flexible structure, by bringing the coated surfaces of said first flexible structure and said second flexible structure together and by and by pressing said first flexible structure and said second flexible structure together to create a cold welding between said first flexible structure and said second flexible structure.

25. A capacitor according to claim 24, whereby said first flexible substrate and said second flexible substrate comprise a metal substrate and a ceramic layer, said ceramic layer having a relative dielectric constant εᵣ higher than 20 and a thickness lower than 1 μm.

26. A superconductor comprising a laminated structure as defined in claim 12.
